(19) United States
(12) Patent Application Publication
(10) Pub. No.: US 2012/0179493 A1
(43) Pub. Date: Jul. 12, 2012

(54) Simple Metering Automatic Real Time Insurance (SMARTI)

(76) Inventor: James Richard Giordano, New Canaan, CT (US)

(21) Appl. No.: 12/940,135

(22) Filed: Dec. 13, 2010

(51) Int. Cl. G06Q 40/08

(52) U.S. Cl. 705/4

(57) ABSTRACT

A metering system used to monitor usage and characteristic attributes through remote links and data transmission whereas an activation occurs and information is transmitted streaming to a processor whereas said information is then transmitted from said processor to a relay station whereas said relay station transmits said information to a control base processor whereas said control base processor evaluates and performs calculations to further relay processed information allowing for efficient usage and attribute characteristic determination and increased efficiency and accountability.

### FIELD OF THE INVENTION

The invention initially will be used to enhance and optimize risk stratification of vehicle insurance. Additionally it will compile, store and offer data allowing for analysis of unique and special attributes.

### BACKGROUND OF THE INVENTION

The invention came about to provide consumers with a more applicable vehicle insurance based upon actual and real time operating habits and attributes. As an owner of both a recreational car and boat it is currently without available consideration of operation and conditions the amount one pays for insurance premiums. During the summer months I operate both considerably more than during the winter. In fact during the winter my car is removed from the standard insurance and is covered for its storage protection and non road usage. The boat insurer does not offer similar types of coverage so one pays for the months of non usage as well. Ironically this year I moved the boat from its dock in the north to a southern state and my insurance increased dramatically. The funny thing is that I will use the boat far fewer hours docked now where it is. So the need for a far more efficient and individualized insurance program came to creation. How nice it would be if during those harsh winter months, one of those special extraordinary mild weather days happened to come and that you could just pull that special car out of storage and go for a pleasure drive and be covered with collision insurance just for the time you needed it then returned it to the garage and returned to storage mode. A solution is to create a method and software to enable for a simple real time automatic metering and valuation system for actuarial premium consideration for vehicle insurance. Current insurance premiums and products have become commoditized with little substantial differentiation and or value to the end users and providers. This invention will provide both insurer and insured a detailed actual vehicle insurance program reflecting and evaluating specific attributes of individual usage and conditions rather than the industry standard of a commoditized actuarial based program. Simply put vehicles not operating (defined as engine not running) would have substantially reduced insurance presidiums than under current insurance policies and programs.

Additionally such data collected would and could have substantial value for government, business and consumers alike.

### SUMMARY OF THE INVENTION

A modified insurance program utilizing Simple Metering Automatic Real Time Insurance, “SMARTI” will allow for better actuarial components that are used in the pricing of the premium. It will provide better information and data pertaining to risk components and allow for better risk/premium matrixes both for the benefit of the insured and insurer. A vehicle participating in this program would enroll in the program provided the vehicle had telematics installed. All manufactures either license or have their own proprietary telematic systems installed in new vehicles today. These devices allow for access of cell service, global positioning services, digital music, or other manufacturer OEM type telematics. Additionally new cars have original equipment device features that are similar to black boxes that are required on airplanes that act as recorders.

How It Works

Once the ignition is activated and the engine is started the Advanced Notification System, “ANS” (black box) is alerted and records the event. Metering is now starting to record and memorialize concurrent events to better provide attributes for premium pricing. Once a communication network link is available a signal/message is sent to a Remote Service Server, “RSS” via the Vehicle Communication Interface Module, “VCIM”. The RSS now indentifies the account policy holder via the signal/message and begins the process of real time pricing of the insurance based upon defined available and collectable data in addition to the initial ANS signal received from the VCIM. Actuarial Real Time Algorithms, “ARTA” will process data inputs and together with actuarial (risk adjusted pricing) definitions will compile price premium details for defined periods of time (hourly, daily, monthly etc.). Insurance policy accounts could have predetermined credit balances with automatic replenishment parameters that become trigged when established balances or driving habits change.

Attributes

Because we can capture the instance of coverage and all available attributes associated with characteristics of pricing in real time we can provide the purest and best of breed insurance available to date. Attributes of pricing algorithms can include the following:

Non specific identification operators will be rated based upon operational pattern recognition analysis.

Specific driver identification listed and identified operator under policy or guest operator provision. This will allow for a far more actual and risk adjusted aspect that is not currently available. There may be many ways to accomplish this identification better in the future but currently this feature may involve the driver being proactive to identify oneself through a variety of resources. Create a process of a user id and login via multiple platforms.

System will allow for logging time of activation and deactivation of use. This is not a currently available resource for an attribute in actuarial pricing of risk for vehicle insurance.

Actual location of the vehicle when operation commences through global positioning and telematics allows for the RSS to rate the degree of risk in a geographical location that is dynamic.

Once time and location are established allow weather conditions to become part of available data to assess and rate road conditions into pricing model. The RSS once knowing time and location can go out and collect local weather conditions and provide actual real time data for ARTA.

Driving speed can additionally be determined and sent via the VCIM to the RSS. The RSS can then determine posted speed limits in actual real time locations. This will significantly add to providing both the insurer and the insured with quantifiable rates based upon actual driving habits. This program could be one the policy holder decides whether to opt in or out of but offering a true reward for the safer driver.

Driver identification, time of day, driving conditions and speed will provide Actuarial Real Time Algorithm, “ARTA” pricing of risk which has never before been available for the insured or insurer. Being able to price risk more accurately allows savings for everyone.

Additional Objectives of the Invention

Fleet owners would have a means of monitoring fleet usage and be able to improve efficiency creating better yield.

The RSS remote service server will be able to compile valuable information and resale date to a multiple of industry parties.

### BRIEF DESCRIPTION OF THE DRAWINGS

FIG. 1. Non indentified or indentified operator starts vehicle. Advanced Notification System records vehicle identity, time and location.

FIG. 2. Vehicle Communication Interface Module sends data that has been recorded by the Advanced Notification System.

FIG. 3. Communication interface receives and relays information to the Remote Service Servers.

FIG. 4. Remote Service Servers collect data and process policy usage. Additionally they request and receive real time driving conditions as well as commence operational pattern recognition when needed. All actuarial data is sent for Actuarial Real Time Algorithmic Analysis.

FIG. 5. Through Actuarial Real Time Algorithms rates and premium are determined based upon real time date and actual operator patterns.

FIG. 6. Policy pricing occurs in real time providing savings both for the insured and insurer.

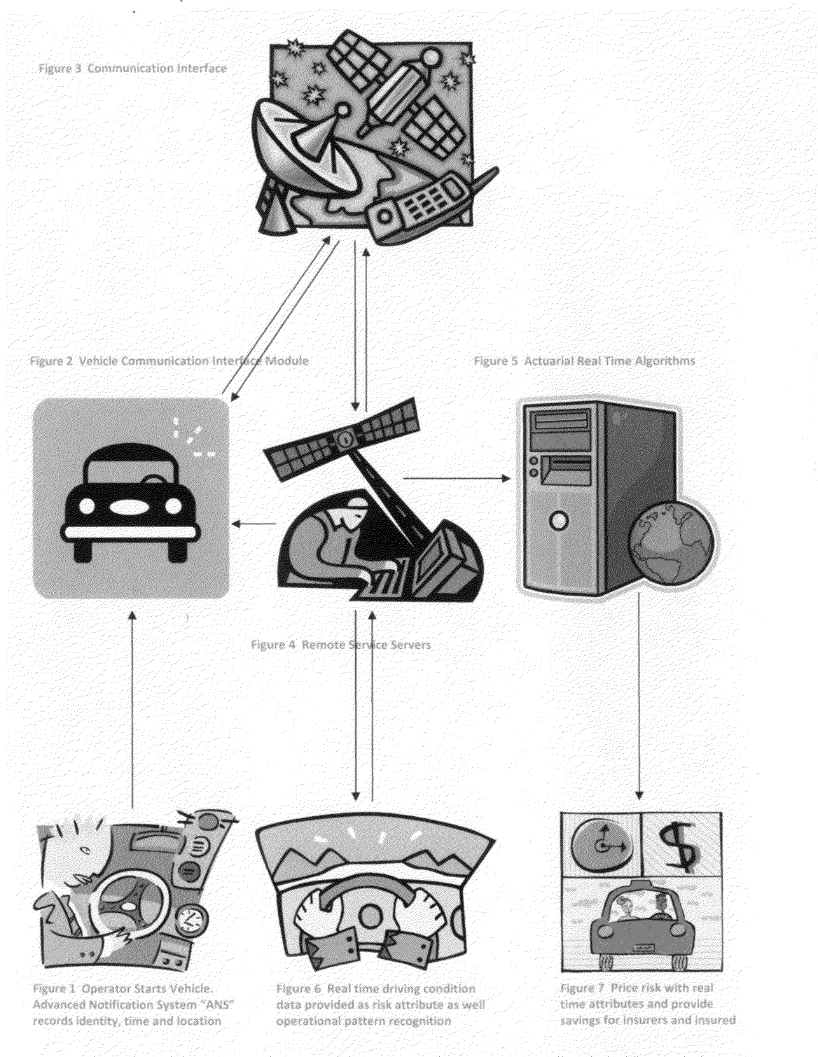

### ELEMENTS OF ACTUARIAL REAL TIME ALGORITHM

Operator characteristics are captured through pattern recognition. These patterns are identified and categorized in risk stratification order based on operational characteristics. These become graded as one aspect of the components involved in actuarial analysis and premium determination. Other elements that contribute to pricing include time duration of operation, time of day, weather conditions, geographic/demographic operational area, highway or city operating conditions, posted speed adherence and vehicle service/maintenance profile. The algorithms will evolve and become dynamic as more data is compiled and the basis for analysis is expanded with more data sets becoming available with loss statistics both implied and actual.

What the invention claimed is:

1. A metering system that records and transmits streaming data about attributes and specifics characteristics of the monitored process through the use of processors and relaying data and information transmissions to control centers allowing control centers to analyze and perform various calculations enabling for greater variable and enhanced service dependent of received data.

2. By being able to quantify better criteria and data inputs the resulting analysis will allow for better pricing of service and resulting greater efficiency if applicable to a process.

3. Through this advanced process of monitoring greater accountability and increased responsibility can be conveyed to participants or operators of the process.

4. Because of increased monitoring participants or operators are able to quantitatively see how performance is achieved based up the then ability to provide performance based procedures and protocol for a defined process.
